(19) United States
(12) Patent Application Publication
(10) Pub. No.: US 2026/0092856 A1
(43) Pub. Date: Apr. 2, 2026

(54) AEROSOL DETECTOR USING INCOHERENT LIGHT SOURCE AND OPTICAL CAVITY

(71) Applicant: Georgia Tech Research Corporation, Atlanta, GA (US)

(72) Inventors: Chandra Raman, Atlanta, GA (US); Jacob Williamson, Atlanta, GA (US); Pranav C. Muthukrishnan, Atlanta, GA (US)

(21) Appl. No.: 19/345,799

(22) Filed: Sep. 30, 2025

Related U.S. Application Data
(60) Provisional application No. 63/701,085, filed on Sep. 30, 2024.

(51) Int. Cl. G01N 15/075; G01N 15/00; G01N 15/0205; G01N 15/0227

(52) U.S. Cl. CPC G01N 15/075; G01N 15/0211; G01N 15/0227; G01N 2015/0026; G01N 2015/025

(57) ABSTRACT

The present disclosure provides an aerosol particle detection system comprising an incoherent light source configured to generate incoherent light, a first mirror and a second mirror positioned to define an optical cavity region therebetween, wherein the optical cavity region receives the incoherent light and allows particles to pass through, and a photodetector positioned to detect transmitted light that has passed through the optical cavity region, wherein the photodetector detects changes in intensity of the transmitted light caused by particles passing through the optical cavity region. The incoherent light source comprises a light-emitting diode configured to emit blue light having a wavelength centered at approximately 430 nanometers. The optical cavity region has a length of approximately 6-10 millimeters. The system further comprises an enclosure defining the optical cavity region with an opening configured to allow particles to enter.

### CROSS-REFERENCE TO RELATED APPLICATIONS

This application claims the benefit of U.S. Provisional Application No. 63/701,085, titled “Aerosol Detector Using Incoherent Light Source and Optical Cavity,” filed 30 Sep. 2024, which is hereby incorporated by reference in its entirety.

### GOVERNMENT LICENSE RIGHTS

This invention was made with government support under FA9453-21-2-0064, awarded by the Department of Defense. The government has certain rights in this invention.

### FIELD OF INVENTION

The present disclosure relates to aerosol particle detection systems, and more particularly to an aerosol detector using an incoherent light source and optical cavity for detecting small particulate matter in air.

### BACKGROUND

Small airborne particles with diameters below 10 micrometers are associated with negative health effects and are monitored in both outdoor and built environments. Optical particle counters available on the market are typically large and expensive relative to mass-produced electronic sensors. These sensors commonly use scattering from a laser beam to detect and count particles in an airflow, where particles enter the laser beam and scatter radiation in all directions, with a portion of the scattered light impinging on a photodetector that converts it into an electrical signal.

Laser-based particle detection systems rely on highly collimated and directional laser output for their design. However, lasers add substantial cost to sensors, even though their coherence properties are not strictly necessary for sensor operation. Less expensive, incoherent light sources would produce similar scattering signals, but they are not commonly used in sensors with small form factors because their direction is more difficult to control and they cannot be easily steered away from the detector as can a laser.

Even with highly directional lasers, further miniaturization becomes challenging because nearby surfaces can scatter light into the detector and create unwanted background signals. These problems—the expense of lasers and the difficulty in miniaturizing scattering sensors—impact the cost and portability of optical aerosol detectors. For these reasons, particle detectors remain somewhat of a specialty item rather than mass-produced electronic sensors comparable to carbon dioxide sensors or smoke detectors found in homes.

If incoherent light sources could be effectively used instead of lasers, particle sensors could potentially be manufactured at costs comparable to other mass-produced electronic sensors. Additionally, scattering signals from sub-micron airborne particles are wavelength dependent, with blue light providing enhanced signals compared to red wavelengths for particles in certain size ranges. While blue lasers are considerably more expensive than red lasers, light-emitting diodes are readily and inexpensively available in blue wavelengths.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an aerosol particle detection system is provided. The aerosol particle detection system comprises an incoherent light source configured to generate incoherent light. The system comprises a first mirror and a second mirror positioned to define an optical cavity region therebetween, wherein the optical cavity region is configured to receive the incoherent light from the incoherent light source and to allow particles to pass through the optical cavity region. The system comprises a photodetector positioned to detect transmitted light that has passed through the optical cavity region, wherein the photodetector is configured to detect changes in intensity of the transmitted light caused by particles passing through the optical cavity region.

According to other aspects of the present disclosure, the aerosol particle detection system may include one or more of the following features. The incoherent light source may comprise a light-emitting diode. The light-emitting diode may be configured to emit blue light having a wavelength centered at approximately 430 nanometers. The optical cavity region may have a length between the first mirror and the second mirror of approximately 6-10 millimeters. The system may further comprise an optical element positioned between the incoherent light source and the optical cavity region. The optical element may comprise a lens configured to enhance signal transmission through the optical cavity region. The system may further comprise an enclosure defining the optical cavity region, wherein the enclosure includes an opening configured to allow particles to enter the optical cavity region. The opening may comprise a hole bored through the enclosure. The photodetector may be configured to detect a decrease in intensity of the transmitted light when particles pass through the optical cavity region. The incoherent light source may be configured to excite multiple cavity modes within the optical cavity region, thereby providing stability against environmental perturbations.

According to another aspect of the present disclosure, a method for detecting aerosol particles is provided. The method comprises generating incoherent light using an incoherent light source. The method comprises directing the incoherent light into an optical cavity defined by a first mirror and a second mirror. The method comprises allowing particles to pass through the optical cavity. The method comprises detecting transmitted light that has passed through the optical cavity using a photodetector. The method comprises identifying presence of particles based on changes in intensity of the transmitted light.

According to other aspects of the present disclosure, the method may include one or more of the following features. Generating incoherent light may comprise operating a light-emitting diode. The light-emitting diode may emit blue light having a wavelength centered at approximately 430 nanometers. Identifying presence of particles may comprise detecting a decrease in intensity of the transmitted light when particles pass through the optical cavity. The method may further comprise a step of filtering the incoherent light through an optical element positioned between the incoherent light source and the optical cavity to enhance signal transmission.

According to another aspect of the present disclosure, an aerosol detection apparatus is provided. The aerosol detection apparatus comprises a light-emitting diode configured to emit incoherent light. The apparatus comprises an optical cavity comprising opposing mirrors that define a cavity region, wherein the optical cavity is configured to spatially filter the incoherent light and to allow aerosol particles to traverse the cavity region. The apparatus comprises a detection system configured to monitor transmission of light through the optical cavity and to detect reductions in transmitted light intensity corresponding to particle scattering events within the cavity region.

According to other aspects of the present disclosure, the aerosol detection apparatus may include one or more of the following features. The light-emitting diode may be configured to emit blue light having a wavelength centered at approximately 430 nanometers with a full-width at half-maximum of approximately 20 nanometers. The optical cavity may have a length between the opposing mirrors of approximately 6-10 millimeters. The apparatus may further comprise an enclosure defining the cavity region, wherein the enclosure includes an opening configured to allow aerosol particles to enter the cavity region. The detection system may comprise a photodetector and an amplifier, and wherein the amplifier may be configured to amplify signals from the photodetector.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A illustrates exemplary forms of airborne particulate matter for which detection ability is desired.

FIG. 1B illustrates the principal of operation for a conventional particle detection system.

FIG. 2 illustrates an incoherent light particle sensor with an optical cavity, according to aspects of the present disclosure.

FIG. 3 provides plots illustrating sensing of particles flowing through a incoherent light particle sensor, according to aspects of the present disclosure.

FIG. 4 depicts photodiode voltage measurements comparing different filter configurations in an incoherent light particle sensor, according to aspects of the present disclosure.

FIG. 5 depicts filter efficiency curves for different MERV ratings of tested filters, according to aspects of the present disclosure.

FIG. 6 depicts a comparison of cavity modes between laser and LED light sources, according to aspects of the present disclosure.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the”include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free”of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

Aerosol particle detection systems may utilize various optical techniques to identify and quantify airborne particulate matter. Traditional approaches commonly employ laser-based light sources to generate coherent beams that interact with particles through scattering mechanisms. However, such conventional systems may present limitations related to cost, complexity, and sensitivity to environmental perturbations. Alternative approaches utilizing incoherent light sources may provide advantages in terms of manufacturing cost, system stability, and miniaturization potential.

An aerosol particle detection system utilizing incoherent light sources may offer several benefits compared to laser-based configurations. Incoherent light sources, such as light-emitting diodes, may be substantially less expensive than laser sources while providing comparable detection capabilities. The broad spectral characteristics of incoherent sources may enable excitation of multiple optical cavity modes simultaneously, which may result in enhanced stability against mechanical vibrations and thermal fluctuations. In some cases, the use of incoherent light sources may eliminate the need for active stabilization systems that are typically associated with coherent laser-based detection systems.

The detection approach may employ transmission-based measurement techniques rather than scattering-based detection methods. In transmission-based systems, particles passing through an optical cavity may cause reductions in transmitted light intensity, which may be detected and analyzed to determine particle characteristics. This approach may provide enhanced sensitivity compared to scattering-based methods since the transmission measurement may capture the total scattered light rather than only a portion intercepted by a detector positioned at a specific angle. Additionally, transmission-based detection may be less susceptible to background contamination that can occur in miniaturized scattering-based systems.

A method for detecting aerosol particles may involve directing incoherent light through an optical cavity and monitoring changes in transmitted light intensity. The optical cavity may serve dual functions as both a spatial filter for the divergent incoherent light and as an enhancement mechanism for particle-light interactions. When particles traverse the cavity region, the multiple reflections between cavity mirrors may increase the effective path length for light-particle interactions, thereby amplifying the detection signal. The method may enable detection of small particles while maintaining a compact system geometry suitable for portable applications.

An aerosol detection apparatus incorporating incoherent light sources and optical cavities may provide a cost-effective solution for air quality monitoring applications. The apparatus may be configured to operate in various environments without the complexity associated with laser-based systems. The incoherent nature of the light source may provide inherent immunity to optical feedback and cavity length fluctuations that can adversely affect laser-based detection systems. In some cases, the apparatus may be designed to fit within compact form factors while maintaining detection sensitivity comparable to larger conventional systems.

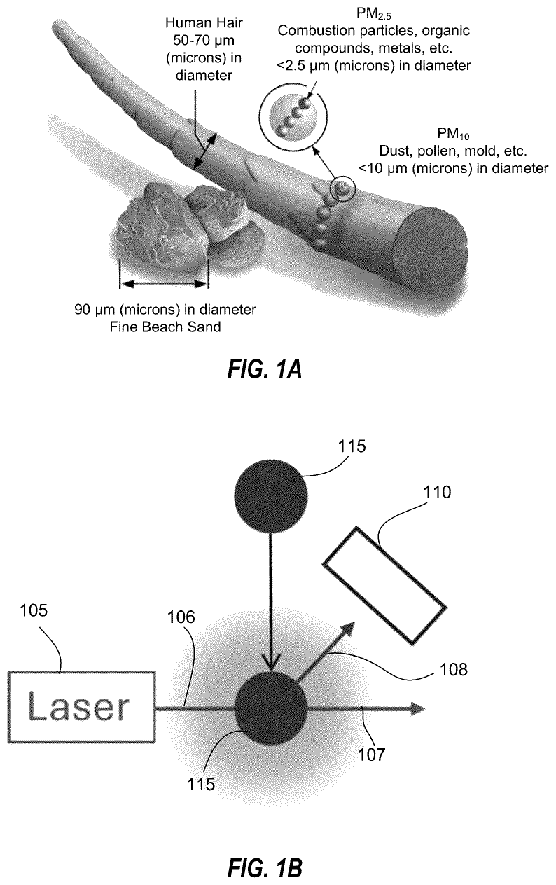

Referring to FIGS. 1A-1B, conventional particle detection systems may employ laser-based optical configurations for identifying and quantifying airborne particulate matter. A laser source 105 may generate a highly collimated and coherent incident beam 106 that propagates through a detection region where particles may be present. The incident beam 106 may continue as a transmitted beam 107 after passing through the interaction region, maintaining its directional characteristics due to the coherent nature of the laser output. When a particle 115 enters the path of the incident beam 106, the particle 115 may cause scattering of the laser light in multiple directions. The scattered light may travel along a scattered light path 108 toward a photodetector 110 positioned at a specific angle relative to the incident beam 106. The photodetector 110 may convert the scattered light into electrical signals that can be processed to determine particle characteristics such as size, concentration, or other properties.

The scattering-based detection approach utilized in conventional systems may present several operational limitations that affect system performance and implementation. The laser source 105 may contribute substantial cost to the overall system, even though the coherence properties of the laser output may not be utilized for the scattering detection process. The photodetector 110 may capture only a portion of the total scattered light from the particle 115, since the scattered light path 108 represents a limited solid angle of the total scattering pattern. This partial collection of scattered light may result in reduced detection sensitivity compared to approaches that capture the total scattering signal. Additionally, the positioning of the photodetector 110 away from the transmitted beam 107 may be necessary to avoid contamination from direct laser light, which may impose geometric constraints on system miniaturization.

With continued reference to FIGS. 1A-1B, the coherent nature of the laser source 105 may introduce stability challenges in compact detection systems. The incident beam 106 may be susceptible to optical feedback effects when reflected surfaces are present in close proximity to the laser source 105. Environmental perturbations such as mechanical vibrations or temperature fluctuations may affect the coherence properties of the incident beam 106, potentially leading to signal variations that are unrelated to particle detection events. The transmitted beam 107 may maintain its coherent characteristics, which may contribute to interference effects when multiple optical surfaces are present within the detection system. These coherence-related effects may necessitate active stabilization systems or careful optical isolation to maintain consistent detection performance.

The geometric requirements of conventional scattering-based systems may impose limitations on device miniaturization and manufacturing cost reduction. The separation between the incident beam 106 and the photodetector 110 may be determined by the need to avoid direct illumination of the photodetector 110 by the transmitted beam 107. As system dimensions are reduced, nearby surfaces may contribute additional scattered light that can reach the photodetector 110 via the scattered light path 108, creating background signals that may interfere with particle detection. The laser source 105 may require precise alignment and mounting to maintain the directional characteristics of the incident beam 106, which may add complexity to manufacturing processes. In some cases, the cost and complexity associated with laser-based detection systems may limit their adoption in mass-market applications where cost-effective particle monitoring may be beneficial.

Incoherent light sources may provide several operational advantages for aerosol particle detection applications compared to coherent laser sources. An incoherent light source may generate electromagnetic radiation that lacks the phase coherence characteristics associated with laser output, which may result in broader spectral distributions and reduced sensitivity to optical feedback effects. The incoherent nature of the light output may enable simultaneous excitation of multiple optical cavity modes, which may contribute to enhanced system stability in the presence of mechanical vibrations or thermal fluctuations. In some cases, incoherent light sources may be manufactured at substantially lower costs than equivalent laser sources while providing comparable optical power levels for particle detection applications.

Light-emitting diodes may serve as practical incoherent light sources for aerosol detection systems due to their combination of cost-effectiveness, reliability, and spectral characteristics. A light-emitting diode may generate incoherent light through electroluminescence processes that occur within semiconductor junction regions when electrical current flows through the device. The spectral output of a light-emitting diode may typically exhibit a broader bandwidth compared to laser sources, which may range from approximately 10 nanometers to 50 nanometers in full-width at half-maximum depending on the specific semiconductor materials and device construction. The incoherent nature of light-emitting diode output may eliminate concerns related to optical feedback that can affect laser-based detection systems when reflective surfaces are present in close proximity to the light source.

The wavelength characteristics of the incoherent light source may be selected to optimize particle scattering interactions for enhanced detection sensitivity. Blue light having a wavelength centered at approximately 430 nanometers may provide enhanced scattering cross-sections for submicron particles compared to longer wavelength sources such as red or infrared light. The scattering efficiency for particles in the 0.3 to 0.5 micrometer size range may be increased by a factor of approximately 2 to 3 when blue light is utilized compared to red wavelengths, which may result in improved signal-to-noise ratios for particle detection events. A light-emitting diode configured to emit blue light may be readily available from commercial suppliers at costs substantially lower than equivalent blue laser sources, which may contribute to overall system cost reduction.

The spectral bandwidth of the incoherent light source may affect the optical cavity performance and detection system stability. A full-width at half-maximum of approximately 20 nanometers may provide sufficient spectral breadth to excite multiple cavity modes simultaneously while maintaining adequate optical power density for particle detection applications. The broader spectral distribution may reduce the sensitivity of the detection system to cavity length variations that can occur due to thermal expansion or mechanical perturbations. In some cases, the spectral bandwidth may be tailored through selection of specific semiconductor materials or through the use of optical filtering techniques to optimize the balance between optical power and spectral characteristics.

Superluminescent diodes may serve as alternative incoherent light sources that combine characteristics of both light-emitting diodes and laser diodes. A superluminescent diode may generate incoherent light through amplified spontaneous emission processes that occur within an optical gain medium, which may result in higher optical power output compared to conventional light-emitting diodes while maintaining the incoherent spectral characteristics. The output of a superluminescent diode may exhibit reduced spatial coherence compared to laser sources, which may provide similar stability advantages to light-emitting diodes in optical cavity applications. In some cases, superluminescent diodes may offer improved coupling efficiency into optical cavities due to their higher radiance compared to conventional light-emitting diodes.

The electrical operating parameters of the incoherent light source may be selected to provide adequate optical power while maintaining device reliability and energy efficiency. An operating voltage of 3.5 volts may be applied to the light-emitting diode to generate an optical power output of approximately 11.35 milliwatts, which may provide sufficient illumination for particle detection applications while remaining within the safe operating limits of typical semiconductor devices. The electrical power consumption at these operating conditions may be compatible with battery-powered portable detection systems, which may enable field deployment applications where external power sources are not readily available. The operating voltage may be provided by standard electronic power supply circuits that can be integrated into compact detection system designs.

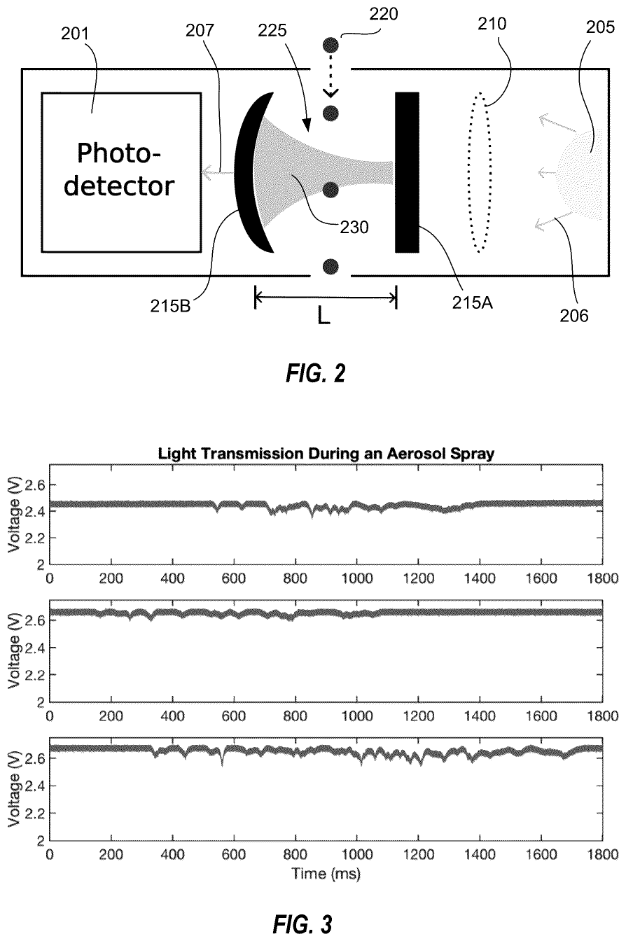

Referring to FIG. 2, an optical cavity system may provide spatial filtering and signal enhancement capabilities for incoherent light-based particle detection applications. A light source 205 may generate incoherent light 206 that propagates toward an optical cavity structure configured to modify the spatial and spectral characteristics of the light output. The optical cavity may comprise a first mirror 215A and a second mirror 215B positioned to define a cavity region 225 therebetween, where the mirrors may be arranged in an opposing configuration to enable multiple reflections of the incoherent light 206 within the cavity region 225. The cavity region 225 may be configured to receive the incoherent light 206 from the light source 205 and to allow particles 220 to pass through the cavity region 225 during detection operations. A photodetector 201 may be positioned to detect transmitted light 207 that has passed through the cavity region 225, where the transmitted light 207 may exhibit modified characteristics compared to the original incoherent light 206 due to the spatial filtering effects of the optical cavity.

The dimensional characteristics of the optical cavity may be selected to provide appropriate spatial filtering while maintaining compatibility with compact system designs. The cavity region 225 may have a length between the first mirror 215A and the second mirror 215B of approximately 6-10 millimeters (though the disclosure is not so limited), which may provide sufficient optical path length for effective spatial filtering of the incoherent light 206 while enabling miniaturization of the overall detection system. In some cases, the cavity region 225 may have a length L of approximately 8 millimeters as a specific implementation that balances spatial filtering performance with system compactness. The length L may be measured as the distance between the reflective surfaces of the first mirror 215A and the second mirror 215B, where the reflective surfaces may be oriented substantially parallel to each other to enable efficient optical cavity operation.

With continued reference to FIG. 2, the optical cavity may serve dual functions as both a spatial filter for the divergent incoherent light 206 and as an interaction region where particles 220 may traverse the optical path. The first mirror 215A and the second mirror 215B may be configured to reflect the incoherent light 206 multiple times within the cavity region 225, which may result in spatial filtering that reduces the divergence of the transmitted light 207 compared to the original incoherent light 206. When a particle 220 enters the cavity region 225, a particle beam interaction 230 may occur where the particle 220 interacts with the incoherent light 206 through scattering processes. The multiple reflections within the cavity region 225 may increase the effective path length for the particle beam interaction 230, which may enhance the detection sensitivity compared to single-pass optical configurations.

The optical cavity may be configured to spatially filter the incoherent light 206 by selectively transmitting light rays that propagate at angles within a specific angular range while attenuating light rays that propagate at larger angles relative to the optical axis. The first mirror 215A may receive the incoherent light 206 from the light source 205 and reflect a portion of the light back toward the second mirror 215B, while simultaneously transmitting a portion of the light toward the second mirror 215B. The second mirror 215B may similarly reflect a portion of the light back toward the first mirror 215A while transmitting a portion as the transmitted light 207 toward the photodetector 201. The multiple reflections between the first mirror 215A and the second mirror 215B may result in constructive interference for light rays that satisfy the cavity resonance conditions, while light rays at other angles may experience destructive interference and be attenuated.

The cavity region 225 may be designed to allow particles 220 to traverse the optical path without mechanical obstruction while maintaining the optical characteristics of the cavity system. As shown in FIG. 2, particles 220 may enter the cavity region 225 and pass through the space between the first mirror 215A and the second mirror 215B, where the particle beam interaction 230 may occur as the particles 220 intersect with the incoherent light 206. The cavity region 225 may be configured with openings or apertures that enable particle flow while preserving the optical isolation of the cavity from external light sources. In some cases, the cavity region 225 may be enclosed within a housing structure that includes openings specifically designed to allow particles 220 to enter and exit the cavity region 225 while preventing contamination of the optical measurements by ambient light.

The optical cavity system may provide enhanced stability for particle detection applications compared to free-space optical configurations due to the multiple cavity modes that may be simultaneously excited by the incoherent light 206. The broad spectral characteristics of the incoherent light 206 may enable excitation of multiple resonant modes within the cavity region 225, which may result in reduced sensitivity to mechanical vibrations or thermal fluctuations that could affect the cavity length. When particles 220 pass through the cavity region 225, the particle beam interaction 230 may cause a reduction in the intensity of the transmitted light 207 that may be detected by the photodetector 201. The magnitude of the intensity reduction may be related to the scattering cross-section of the particle 220 and the number of times the incoherent light 206 interacts with the particle 220 during the multiple reflections within the cavity region 225.

With continued reference to FIG. 2, an optical element 210 may be positioned between the light source 205 and the optical cavity to enhance the coupling efficiency and signal transmission characteristics of the detection system. The optical element 210 may be configured to modify the spatial distribution, divergence angle, or other optical properties of the incoherent light 206 before the incoherent light 206 enters the cavity region 225. The positioning of the optical element 210 between the light source 205 and the first mirror 215A may enable optimization of the light coupling into the optical cavity while maintaining the compact geometry of the overall detection system. In some cases, the optical element 210 may serve to reduce the divergence of the incoherent light 206, which may improve the spatial overlap between the incoherent light 206 and the resonant modes supported by the cavity region 225.

The optical element 210 may comprise a lens configured to enhance signal transmission through the optical cavity region 225 by modifying the wavefront characteristics of the incoherent light 206. A lens configuration may provide focusing or collimation of the incoherent light 206 to match the spatial mode structure of the optical cavity formed by the first mirror 215A and the second mirror 215B. The lens may be selected to have appropriate focal length and numerical aperture characteristics that optimize the coupling efficiency between the light source 205 and the cavity region 225. In some cases, the optical element 210 may comprise a single lens element, while in other configurations multiple lens elements may be arranged to provide enhanced optical performance or to correct for aberrations that could affect the spatial quality of the incoherent light 206.

The optical element 210 may function as a spatial filter that selectively transmits portions of the incoherent light 206 that propagate within specific angular ranges while attenuating light rays that propagate at larger divergence angles. The filtering action of the optical element 210 may reduce the angular spread of the incoherent light 206, which may result in improved coupling efficiency into the cavity region 225 and enhanced stability of the transmitted light 207 detected by the photodetector 201. The spatial filtering characteristics of the optical element 210 may be particularly beneficial when the light source 205 exhibits high divergence angles that would otherwise result in poor coupling into the optical cavity. In some cases, the optical element 210 may be designed to match the numerical aperture of the light source 205 to the acceptance angle of the optical cavity to maximize the fraction of the incoherent light 206 that contributes to the transmitted light 207.

As shown in FIG. 2, the optical element 210 may be positioned at a specific distance from the light source 205 and the first mirror 215A to achieve the desired optical performance characteristics. The positioning of the optical element 210 may be determined by the focal length of the lens and the desired beam characteristics at the entrance to the cavity region 225. The optical element 210 may be configured to collect a substantial portion of the incoherent light 206 emitted by the light source 205 and redirect the incoherent light 206 toward the first mirror 215A with reduced divergence compared to the original emission pattern. The enhanced coupling efficiency provided by the optical element 210 may result in increased optical power within the cavity region 225, which may improve the signal-to-noise ratio for particle detection events when particles 220 traverse the cavity region 225 and create particle beam interactions 230.

The optical element 210 may provide wavelength-dependent filtering effects that can enhance the spectral characteristics of the incoherent light 206 for particle detection applications. Lens materials may exhibit wavelength-dependent transmission properties that can selectively enhance or attenuate specific portions of the spectrum emitted by the light source 205. In some cases, the optical element 210 may be designed to preferentially transmit blue wavelengths that provide enhanced scattering cross-sections for submicron particles while attenuating longer wavelengths that may contribute less to the particle detection signal. The spectral filtering effects of the optical element 210 may complement the spatial filtering functions to provide overall system optimization for particle detection sensitivity and stability.

The optical element 210 may be configured to reduce the sensitivity of the detection system to mechanical misalignments or thermal variations that could affect the coupling between the light source 205 and the cavity region 225. The focusing or collimation provided by the optical element 210 may create a more uniform illumination pattern at the entrance to the cavity region 225, which may reduce the impact of small positional variations of the light source 205 on the overall system performance. In some cases, the optical element 210 may be designed with sufficient numerical aperture to maintain adequate coupling efficiency even when minor mechanical perturbations occur due to environmental conditions or manufacturing tolerances. The enhanced stability provided by the optical element 210 may contribute to consistent detection performance across varying operating conditions without the need for active alignment systems.

With continued reference to FIG. 2, the photodetector 201 may be positioned to detect the transmitted light 207 that has passed through the cavity region 225 and to monitor changes in the optical characteristics of the transmitted light 207 that may occur when particles 220 traverse the cavity region 225. The photodetector 201 may be configured to convert optical signals into electrical signals that can be processed and analyzed to determine the presence and characteristics of particles 220 within the cavity region 225. The positioning of the photodetector 201 may be selected to maximize the collection efficiency of the transmitted light 207 while minimizing the detection of scattered light or other optical signals that could interfere with particle detection measurements. The photodetector 201 may be aligned with the optical axis of the cavity system to receive the transmitted light 207 that has been spatially filtered by the optical cavity formed by the first mirror 215A and the second mirror 215B.

The photodetector 201 may comprise a photodiode configured to generate electrical current proportional to the intensity of the transmitted light 207 incident upon the photodiode surface. A photodiode may provide rapid response times and high sensitivity to optical signals within the wavelength range of the incoherent light 206 generated by the light source 205. The photodiode may be selected to have spectral response characteristics that match the emission spectrum of the light source 205, which may optimize the signal-to-noise ratio for particle detection applications. In some cases, the photodiode may be configured with appropriate bias voltages and operating conditions to maximize the linearity and stability of the electrical output signal in response to variations in the transmitted light 207 intensity. The photodiode may be housed within a protective enclosure that shields the photodiode from ambient light sources while allowing the transmitted light 207 to reach the photodiode surface.

The photodetector 201 may alternatively comprise a camera configured to capture spatial and temporal information about the transmitted light 207 passing through the cavity region 225. A camera configuration may provide enhanced capabilities for analyzing the spatial distribution of the transmitted light 207 and for detecting particles 220 that may cause localized changes in the optical transmission characteristics. The camera may be equipped with appropriate optical elements such as lenses or filters to optimize the imaging characteristics for particle detection applications. In some cases, the camera may be configured to operate at frame rates sufficient to capture transient events associated with particles 220 passing through the cavity region 225. The camera may provide digital output signals that can be processed using image analysis techniques to extract information about particle characteristics such as size, shape, or trajectory through the cavity region 225.

As shown in FIG. 2, the photodetector 201 may be configured to detect changes in intensity of the transmitted light 207 caused by particles 220 passing through the cavity region 225 and creating particle beam interactions 230. When a particle 220 enters the cavity region 225, the particle 220 may scatter a portion of the incoherent light 206 in directions other than the forward transmission direction, which may result in a reduction in the intensity of the transmitted light 207 detected by the photodetector 201. The magnitude of the intensity reduction may be related to the scattering cross-section of the particle 220, which may depend on factors such as particle size, refractive index, and the wavelength of the incoherent light 206. The photodetector 201 may generate electrical signals that correspond to these intensity variations, enabling the detection and quantification of particles 220 within the cavity region 225.

The photodetector 201 may be configured to detect decreases in intensity of the transmitted light 207 when particles 220 pass through the cavity region 225, where the decreases may correspond to particle scattering events within the cavity region 225. The transmission-based detection approach may provide enhanced sensitivity compared to scattering-based detection methods since the photodetector 201 may capture the total effect of particle scattering rather than only a portion of the scattered light. The multiple reflections of the incoherent light 206 within the cavity region 225 may amplify the interaction between the incoherent light 206 and particles 220, which may result in larger intensity changes in the transmitted light 207 compared to single-pass optical configurations. The photodetector 201 may be calibrated to establish baseline intensity levels for the transmitted light 207 in the absence of particles 220, enabling the detection of intensity decreases that correspond to particle detection events.

With continued reference to FIG. 2, a detection system may be configured to monitor transmission of light through the optical cavity and to process the electrical signals generated by the photodetector 201 in response to changes in the transmitted light 207. The detection system may comprise electronic components configured to amplify, filter, and analyze the electrical signals from the photodetector 201 to extract information about particles 220 passing through the cavity region 225. The detection system may be designed to provide sufficient sensitivity to detect small changes in the transmitted light 207 intensity that may occur when submicron particles 220 traverse the cavity region 225. In some cases, the detection system may include signal processing capabilities to distinguish between particle detection events and other sources of signal variation such as electronic noise or environmental perturbations.

The detection system may comprise an amplifier connected to the photodetector 201 and configured to amplify the electrical signals generated by the photodetector 201 in response to variations in the transmitted light 207 intensity. The amplifier may provide signal conditioning to enhance the signal-to-noise ratio and to convert the electrical signals from the photodetector 201 into voltage levels suitable for further processing and analysis. The amplifier may be configured with appropriate bandwidth characteristics to preserve the temporal information associated with particles 220 passing through the cavity region 225 while attenuating high-frequency noise that could interfere with particle detection measurements. In some cases, the amplifier may include multiple stages of amplification to achieve the desired overall gain while maintaining signal stability and linearity across the expected range of input signal levels.

The amplifier may be configured with a gain of approximately ×10⁹ V/A to provide sufficient amplification of the electrical signals generated by the photodetector 201 when configured as a photodiode. The high gain amplification may enable detection of small changes in the transmitted light 207 intensity that may occur when particles 220 with submicron dimensions pass through the cavity region 225 and create particle beam interactions 230. The gain value may be selected to optimize the balance between signal amplification and noise performance, where higher gain values may increase the sensitivity to particle detection events while potentially increasing the susceptibility to electronic noise sources. The amplifier may be designed with appropriate input impedance characteristics to match the electrical characteristics of the photodetector 201 and to minimize signal degradation due to impedance mismatches.

The detection system may include an oscilloscope connected to record and read data from the amplified photodetector signal generated by the amplifier. The oscilloscope may provide capabilities for capturing and storing the temporal variations in the amplified electrical signals that correspond to particles 220 passing through the cavity region 225. The oscilloscope may be configured with appropriate sampling rates and memory depth to capture transient events associated with particle detection while providing sufficient temporal resolution to analyze the characteristics of individual particle detection events. In some cases, the oscilloscope may include triggering capabilities that enable selective capture of signal variations that exceed predetermined threshold levels, which may facilitate the identification and analysis of particle detection events while reducing the storage requirements for background signal data.

The oscilloscope may be configured to record voltage measurements over time that correspond to the intensity variations in the transmitted light 207 detected by the photodetector 201 and amplified by the amplifier. The recorded data may exhibit characteristic patterns such as temporary decreases in voltage levels that correspond to particles 220 passing through the cavity region 225 and causing reductions in the transmitted light 207 intensity. The oscilloscope may provide digital storage capabilities that enable post-processing analysis of the recorded signals to extract statistical information about particle characteristics such as detection frequency, signal amplitude distributions, or temporal patterns associated with particle flow through the cavity region 225. The oscilloscope may be interfaced with computer systems or data analysis equipment to enable automated processing of the recorded particle detection data.

An enclosure may be configured to define the optical cavity region and to provide structural support for the optical components while enabling particle access to the cavity region. The enclosure may comprise a housing structure that surrounds and protects the first mirror and second mirror while maintaining the precise spacing and alignment between the mirrors that may be required for optical cavity operation. The enclosure may be fabricated from materials that provide mechanical stability and thermal resistance to maintain consistent optical performance across varying environmental conditions. In some cases, the enclosure may be designed to minimize internal reflections or scattering from the enclosure walls that could interfere with the optical measurements within the cavity region. The enclosure may also provide mounting interfaces for the incoherent light source and photodetector to ensure proper alignment with the optical cavity axis.

The enclosure may include an opening configured to allow particles to enter the optical cavity region during detection operations while maintaining optical isolation from external light sources. The opening may be positioned to enable particle flow through the cavity region without disrupting the optical characteristics of the cavity or causing mechanical interference with the mirror surfaces. The size and geometry of the opening may be selected to provide adequate particle access while minimizing the ingress of ambient light that could contaminate the optical measurements. In some cases, the opening may be configured with specific dimensions that balance particle flow requirements with optical isolation performance to optimize the overall detection system sensitivity. The opening may be positioned at locations along the enclosure that correspond to the desired particle trajectory through the cavity region.

The opening may comprise a hole bored through the enclosure to provide a direct pathway for particles to traverse the optical cavity region. The hole may be formed using precision machining techniques to achieve the desired dimensional accuracy and surface finish characteristics that minimize optical scattering or particle flow disruption. The diameter of the hole may be selected to accommodate the expected size range of particles while maintaining structural integrity of the enclosure. In some cases, multiple holes may be bored through the enclosure at different locations to enable particle entry and exit from the cavity region, creating a flow path that allows continuous particle monitoring. The hole may be positioned to intersect the optical path within the cavity region at locations where the light intensity may be sufficient for particle detection while avoiding interference with the mirror surfaces.

The hole may be configured with smooth internal surfaces to minimize particle adhesion or flow disruption that could affect the particle detection measurements. The boring process may be controlled to achieve cylindrical hole geometry with minimal surface roughness that could cause particle scattering or create turbulent flow conditions within the hole. The length of the hole may correspond to the thickness of the enclosure wall, which may be selected to provide adequate structural strength while minimizing the distance that particles travel within the confined hole geometry. In some cases, the hole may be treated with surface coatings or finishes that reduce particle adhesion and facilitate smooth particle flow through the opening. The hole diameter may be sized to accommodate particles across the intended detection size range while preventing larger debris from entering the cavity region.

The enclosure design may enable miniaturization of the aerosol particle detection system to fit within compact volume constraints while maintaining detection performance. The overall system dimensions may be optimized to achieve a total volume of approximately 1 cubic centimeter, which may enable integration into portable devices or deployment in space-constrained applications. The miniaturization may be achieved through careful selection of component dimensions, efficient packaging of optical elements, and optimization of the enclosure geometry to minimize unused internal volume. In some cases, the compact design may facilitate mass production using automated assembly techniques that can reduce manufacturing costs compared to larger detection systems. The miniaturized configuration may enable battery-powered operation for extended periods due to the reduced power consumption associated with smaller optical components and simplified electronic systems.

The 1 cubic centimeter volume constraint may influence the selection of optical cavity dimensions, mirror sizes, and component spacing within the enclosure. The cavity length may be optimized to provide adequate optical performance while fitting within the available space along with the incoherent light source, photodetector, and associated electronic components. The enclosure walls may be designed with minimal thickness to maximize the internal volume available for optical components while maintaining structural integrity and optical isolation. In some cases, the enclosure may incorporate integrated mounting features or alignment structures that eliminate the need for separate mounting hardware, thereby reducing the overall system volume. The compact volume may enable the detection system to be incorporated into wearable devices, environmental monitoring networks, or other applications where size constraints may limit the use of larger particle detection systems.

The enclosure may be configured to provide environmental protection for the optical components while maintaining the compact system geometry. The enclosure may protect the mirrors, incoherent light source, and photodetector from dust, moisture, or other environmental contaminants that could degrade optical performance over time. The enclosure materials may be selected to provide appropriate thermal expansion characteristics that minimize changes in the cavity dimensions due to temperature variations. In some cases, the enclosure may include sealing features around component interfaces to prevent contamination while allowing for the particle access opening. The environmental protection provided by the enclosure may enable reliable operation in outdoor environments or industrial settings where particle detection may be required for air quality monitoring or process control applications.

The structural design of the enclosure may accommodate the mechanical forces and vibrations that may be encountered during operation while maintaining optical alignment within the cavity region. The enclosure may be designed with appropriate wall thickness and reinforcement features to resist deformation that could affect the spacing between the first mirror and second mirror. The mounting interfaces for the optical components may be configured to provide stable support while allowing for thermal expansion or contraction of the components. In some cases, the enclosure may include vibration isolation features that reduce the transmission of external mechanical disturbances to the optical cavity, thereby maintaining stable detection performance in environments with mechanical vibrations. The mechanical stability provided by the enclosure may contribute to consistent particle detection sensitivity without the need for active stabilization systems.

Experimental validation of aerosol particle detection systems may involve controlled testing procedures that utilize standardized particle sources and filtration components to evaluate detection performance across various operating conditions. Testing methodologies may employ aerosolized isopropanol as a particle source to generate controlled aerosol distributions that enable systematic evaluation of detection sensitivity and system response characteristics. Aerosolized isopropanol may provide reproducible particle generation with known size distributions and concentrations, which may facilitate quantitative assessment of detection system performance. The use of isopropanol as a test aerosol may offer advantages in terms of safety, availability, and compatibility with laboratory testing environments compared to other aerosol sources that may present handling or disposal challenges.

The aerosolized isopropanol particle source may be generated using spray techniques that create droplets through atomization processes, where the droplets may subsequently evaporate to leave residual particles suitable for detection testing. The particle size distribution generated by aerosolized isopropanol may encompass the submicron range that may be relevant for air quality monitoring applications, including particles in the 0.3 to 0.5 micrometer size range where enhanced scattering signals may be achieved using blue light wavelengths. The evaporation characteristics of isopropanol may result in particle formation that provides consistent test conditions across multiple experimental trials. In some cases, the concentration of aerosolized isopropanol may be controlled through adjustment of spray parameters such as pressure, flow rate, or nozzle characteristics to achieve desired particle densities for testing purposes.

MERV-rated filters may be incorporated into the testing configuration to evaluate the detection system performance under conditions where larger particles have been selectively removed from the aerosol stream. The Minimum Efficiency Reporting Value rating system may provide standardized characterization of filter performance across different particle size ranges, enabling systematic evaluation of detection system response to filtered aerosol distributions. MERV 4 and MERV 8 filters may be positioned between the aerosol source and the cavity region to create controlled testing conditions where particles above specific size thresholds are removed while allowing smaller particles to reach the detection system. The differential filtration characteristics of MERV 4 and MERV 8 filters may enable assessment of detection system sensitivity to particles in different size ranges by comparing detection results obtained with different filter configurations.

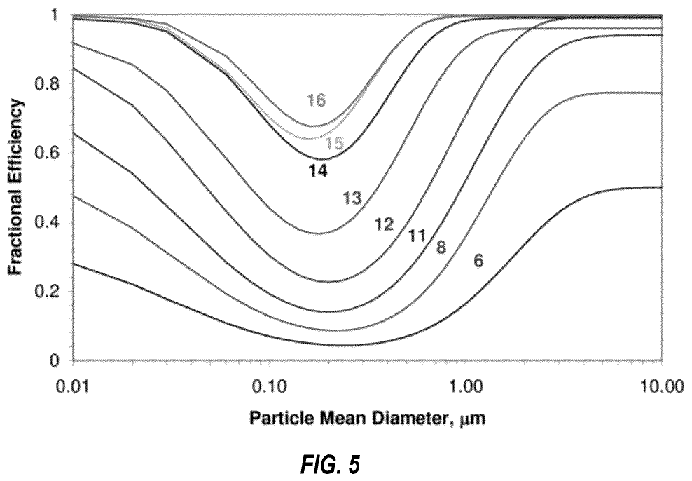

Referring to FIG. 5, filter efficiency characteristics may be evaluated across particle size ranges to establish the filtration performance of different MERV-rated filters used in testing configurations. The filter efficiency curves may demonstrate the fractional efficiency of particle removal as a function of particle mean diameter, where higher MERV ratings may correspond to enhanced filtration performance across the particle size spectrum. MERV 4 filters may exhibit lower efficiency for submicron particles compared to MERV 8 filters, which may result in different particle size distributions reaching the detection system when these filters are employed in testing configurations. The efficiency curves may show that MERV 8 filters provide enhanced removal of particles in the 0.3 to 0.5 micrometer range compared to MERV 4 filters, which may enable evaluation of detection system performance for particles that pass through different levels of filtration.

The filter efficiency comparison may reveal that particles in the submicron range may experience different levels of filtration depending on the MERV rating of the filter employed in the testing configuration. MERV 4 filters may allow a higher fraction of submicron particles to pass through compared to MERV 8 filters, which may result in higher particle concentrations reaching the detection system when MERV 4 filters are used. The differential filtration performance may enable systematic evaluation of detection system sensitivity by comparing the detection response obtained with different filter configurations under otherwise identical testing conditions. In some cases, the filter efficiency data may be used to estimate the particle size distributions that reach the detection system after filtration, enabling correlation between particle characteristics and detection system response.

Blue light wavelengths may provide enhanced scattering cross-sections for particles in the 0.3 to 0.5 micrometer size range compared to longer wavelengths, which may result in improved detection sensitivity for submicron particles that may be present in filtered aerosol streams. The wavelength dependence of particle scattering may follow theoretical relationships that predict enhanced scattering efficiency for blue light compared to red or infrared wavelengths when interacting with particles in the submicron size range. The enhanced scattering signals achieved with blue light may enable detection of particles that might not be detectable using longer wavelength sources, particularly after filtration processes that remove larger particles while allowing submicron particles to pass through. In some cases, the combination of blue light illumination and cavity enhancement may provide sufficient sensitivity to detect individual submicron particles that traverse the cavity region during testing procedures.

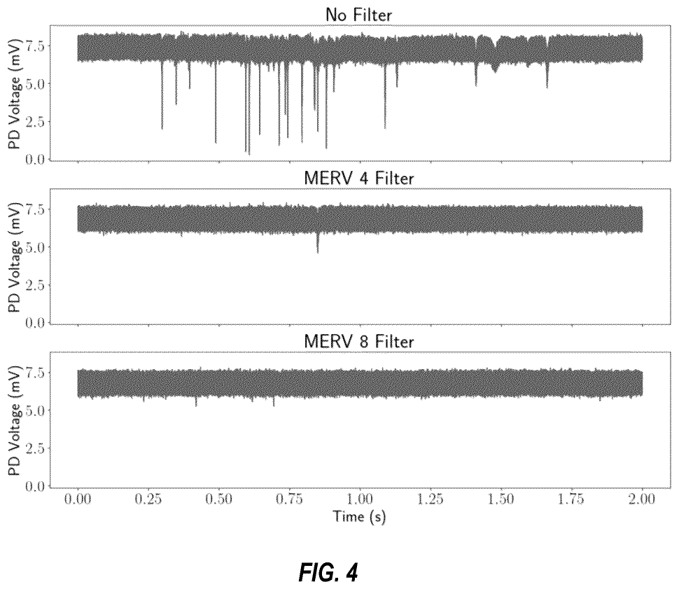

Referring to FIG. 4, photodiode voltage measurements may be recorded over time to capture the detection system response to particles passing through the cavity region under different filtration conditions. The voltage measurements may exhibit characteristic patterns that correspond to particle detection events, where temporary decreases in voltage levels may indicate the presence of particles within the cavity region. The unfiltered measurement configuration may show multiple sharp downward voltage spikes of varying magnitudes, which may correspond to particles of different sizes or particle clusters passing through the detection region. The baseline voltage level may remain relatively stable between particle detection events, indicating consistent optical transmission through the cavity region in the absence of particles.

With continued reference to FIG. 4, the MERV 4 filter configuration may result in fewer and smaller voltage drops compared to the unfiltered measurement, which may indicate that the filter has removed a portion of the particles while allowing smaller particles to reach the detection system. The reduction in the number and magnitude of voltage spikes may correspond to the filtration efficiency of the MERV 4 filter for particles in the size range generated by the aerosolized isopropanol source. The voltage measurements may demonstrate that the detection system maintains sensitivity to particles that pass through the MERV 4 filter, indicating the capability to detect submicron particles that may not be efficiently removed by lower-efficiency filtration systems. The temporal distribution of voltage spikes may provide information about the particle flow characteristics and concentration levels reaching the detection system after filtration.

The MERV 8 filter configuration may exhibit minimal voltage fluctuations compared to both the unfiltered and MERV 4 filter measurements, which may demonstrate the enhanced particle removal efficiency of the higher-rated filter. The reduced detection activity may indicate that the MERV 8 filter removes a larger fraction of particles across the size range generated by the aerosolized isopropanol source, resulting in lower particle concentrations reaching the detection system. The voltage measurements may show occasional small fluctuations that may correspond to submicron particles that pass through the MERV 8 filter, demonstrating the detection system capability to identify particles even after high-efficiency filtration. In some cases, the minimal voltage variations observed with MERV 8 filtration may approach the noise floor of the detection system, indicating that the filter efficiency approaches the detection limit for the particle source and testing conditions employed.

The photodiode voltage measurements may span time periods sufficient to capture statistical information about particle detection events under different filtration conditions, enabling quantitative comparison of detection system performance. The measurement duration may be selected to provide adequate sampling of particle detection events while maintaining manageable data storage and processing requirements. The voltage range observed in the measurements may correspond to the dynamic range of the detection system and the amplification characteristics of the signal conditioning electronics. In some cases, the voltage measurements may be processed to extract statistical parameters such as detection event frequency, signal amplitude distributions, or temporal patterns that characterize the particle detection performance under different testing conditions.

The experimental validation procedures may demonstrate the detection system capability to identify and quantify submicron particles across different filtration scenarios, providing evidence of detection sensitivity and system performance characteristics. The testing results may show that the detection system maintains functionality across the range of particle concentrations and size distributions that may be encountered in practical air quality monitoring applications. The use of standardized MERV-rated filters in the testing configuration may enable comparison of detection system performance with established filtration standards used in air handling and environmental monitoring systems. In some cases, the testing procedures may be extended to include additional filter ratings or particle sources to provide comprehensive characterization of detection system performance across broader ranges of operating conditions.

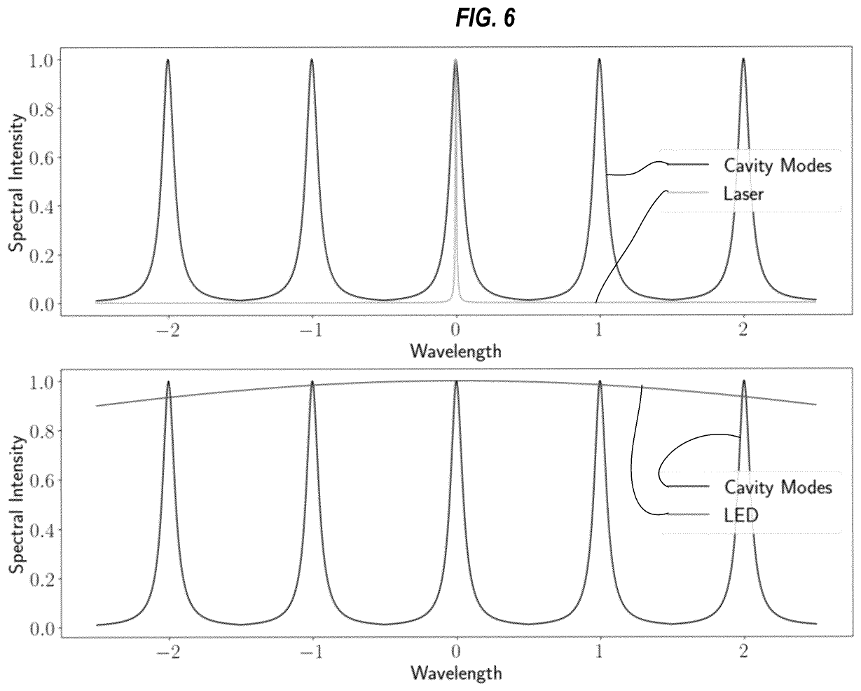

Referring to FIG. 6, the spectral characteristics of different light sources may exhibit distinct interactions with optical cavity modes that affect the stability and performance of particle detection systems. The comparison between cavity modes and laser sources may demonstrate that coherent laser light typically exhibits narrow spectral linewidths that correspond to single longitudinal modes within the optical cavity structure. The laser spectrum may overlap with only one cavity mode at any given time, creating a condition where the optical transmission through the cavity depends on precise alignment between the laser frequency and the cavity resonance frequency. The narrow spectral width of laser sources may result in high sensitivity to cavity length variations, where small changes in the distance between mirrors can shift the cavity modes relative to the laser frequency and cause substantial variations in transmitted optical power.

With continued reference to FIG. 6, incoherent light sources may exhibit broader spectral distributions that enable simultaneous excitation of multiple cavity modes within the optical cavity region. The LED spectrum may span a wavelength range that encompasses several cavity mode resonances, creating conditions where multiple modes contribute to the overall optical transmission through the cavity. The broader spectral characteristics of incoherent sources may result in reduced sensitivity to cavity length fluctuations, since shifts in individual cavity mode frequencies may have minimal impact on the total transmitted power when multiple modes are simultaneously excited. The spectral bandwidth of incoherent sources may provide inherent averaging effects that stabilize the optical transmission against environmental perturbations that could affect cavity dimensions.

The cavity mode structure may be determined by the physical dimensions and optical characteristics of the cavity formed by the opposing mirrors, where the mode spacing may be inversely related to the cavity length. Each cavity mode may correspond to a specific wavelength at which constructive interference occurs between light waves propagating back and forth within the cavity region. The free spectral range of the cavity may define the wavelength separation between adjacent cavity modes, where shorter cavities may exhibit larger mode spacing compared to longer cavities. In some cases, the cavity mode structure may be modified by factors such as mirror reflectivity, cavity geometry, or the presence of optical elements within the cavity region that affect the optical path length or mode characteristics.

The interaction between laser sources and cavity modes may create conditions where environmental perturbations can cause significant variations in optical transmission that are unrelated to particle detection events. Mechanical vibrations may cause minute changes in cavity length that shift the cavity mode frequencies relative to the fixed laser frequency, resulting in periodic fluctuations in transmitted optical power as the system moves in and out of resonance conditions. Temperature variations may cause thermal expansion or contraction of cavity components, leading to drift in cavity mode frequencies that can affect the coupling between the laser source and cavity modes. The coherent nature of laser light may amplify these effects, since the narrow spectral linewidth provides minimal tolerance for frequency mismatches between the laser and cavity resonances.

As shown in FIG. 6, the spectral overlap between incoherent light sources and cavity modes may provide enhanced stability against environmental perturbations compared to laser-based configurations. The broad spectrum of incoherent sources may ensure that multiple cavity modes remain excited even when individual mode frequencies shift due to cavity length variations or thermal effects. The distributed spectral power of incoherent sources may create conditions where the total transmitted optical power remains relatively stable despite fluctuations in individual cavity mode characteristics. In some cases, the stability provided by multiple mode excitation may eliminate the need for active cavity length stabilization systems that may be required for laser-based cavity applications.

The incoherent light source may be configured to excite multiple cavity modes within the optical cavity region, thereby providing stability against environmental perturbations that could otherwise affect particle detection measurements. The spectral bandwidth of the incoherent source may be selected to encompass a sufficient number of cavity modes to achieve the desired stability characteristics while maintaining adequate optical power density for particle detection applications. The multiple mode excitation may create averaging effects that reduce the impact of individual mode fluctuations on the overall system performance. The stability provided by multiple mode operation may enable reliable particle detection in environments where mechanical vibrations, temperature variations, or other perturbations could affect single-mode laser systems.

The environmental perturbations that may affect cavity-based detection systems may include mechanical vibrations from external sources, thermal fluctuations due to ambient temperature changes, or acoustic disturbances that can couple into the optical cavity structure. These perturbations may cause variations in cavity length on the order of fractions of optical wavelengths, which may be sufficient to significantly affect the coupling between coherent laser sources and individual cavity modes. The multiple mode excitation provided by incoherent sources may reduce the sensitivity to such perturbations by distributing the optical power across several cavity modes, where fluctuations in individual modes may be averaged out in the total transmitted signal. In some cases, the stability against environmental perturbations may enable deployment of cavity-enhanced detection systems in field environments where active stabilization systems would be impractical.

The temporal stability characteristics of different light source configurations may be evaluated by monitoring the transmitted optical power through the cavity over extended time periods while the system is subjected to typical environmental conditions. Laser-based systems may exhibit periodic fluctuations in transmitted power that correspond to cavity length variations caused by mechanical or thermal perturbations, where the fluctuation amplitude may depend on the degree of frequency mismatch between the laser and cavity modes. Incoherent light sources may demonstrate enhanced temporal stability with reduced fluctuations in transmitted power under similar environmental conditions, indicating the stabilizing effects of multiple mode excitation. The improved stability may result in more consistent baseline measurements for particle detection applications, reducing the likelihood of false detection events caused by environmental perturbations rather than actual particle interactions.

The frequency stability requirements for cavity-enhanced detection systems may differ substantially between coherent and incoherent light source configurations. Laser-based systems may require active frequency stabilization or cavity length control to maintain optimal coupling between the laser frequency and cavity resonances, adding complexity and cost to the overall detection system. Incoherent sources may operate without active stabilization due to the inherent stability provided by multiple mode excitation, simplifying the system design and reducing power consumption requirements. In some cases, the elimination of active stabilization systems may enable battery-powered operation for extended periods, facilitating portable or remote deployment applications where external power sources may not be available.

The signal-to-noise characteristics of cavity-enhanced detection systems may be affected by the stability properties of different light source configurations. Laser-based systems may experience noise contributions from cavity length fluctuations that create variations in transmitted optical power unrelated to particle detection events, potentially reducing the signal-to-noise ratio for particle measurements. Incoherent sources may provide improved signal-to-noise performance by reducing the amplitude of fluctuations caused by environmental perturbations, enabling detection of smaller particles or operation in more challenging environmental conditions. The enhanced stability may also reduce the need for signal processing techniques designed to compensate for environmental noise, simplifying the detection electronics and data analysis requirements.

The aerosol particle detection system may operate through coordinated interaction of multiple components that work together to generate, process, and analyze optical signals for particle identification purposes. The system operation may begin with the generation of incoherent light that exhibits broad spectral characteristics suitable for cavity-enhanced detection applications. The incoherent light may be directed into an optical cavity where spatial filtering occurs, creating conditions that enable sensitive detection of particles passing through the cavity region. The detection process may rely on monitoring changes in transmitted light intensity that occur when particles interact with the filtered light within the cavity, where the interactions may cause measurable reductions in optical transmission that can be analyzed to determine particle presence and characteristics.

The generation of incoherent light may serve as the foundation for the detection system operation, where the spectral and spatial characteristics of the light source may determine the overall system performance capabilities. The incoherent light generation process may involve electroluminescence within semiconductor materials that produce electromagnetic radiation across a range of wavelengths without the phase coherence associated with laser sources. The broad spectral distribution of the incoherent light may enable simultaneous excitation of multiple optical modes within the cavity system, creating conditions that provide enhanced stability against environmental perturbations compared to coherent light sources. The incoherent nature of the light may eliminate concerns related to optical feedback effects that can affect coherent sources when reflective surfaces are present in close proximity to the light generation region.

The spatial characteristics of the generated incoherent light may exhibit divergence patterns that require modification to achieve efficient coupling into the optical cavity system. The divergent nature of incoherent light sources may result in angular distributions that exceed the acceptance characteristics of optical cavities, potentially leading to reduced coupling efficiency and suboptimal detection performance. The system may incorporate optical elements positioned between the light source and cavity entrance to modify the spatial distribution of the incoherent light, creating beam characteristics that match the spatial mode requirements of the optical cavity. The spatial modification process may involve focusing, collimation, or other beam shaping techniques that optimize the fraction of generated light that contributes to the cavity-enhanced detection process.

The direction of incoherent light into the optical cavity may involve precise alignment and coupling procedures that ensure optimal interaction between the light source and cavity modes. The cavity entrance conditions may be configured to maximize the coupling efficiency while maintaining the spatial filtering characteristics that contribute to detection sensitivity. The incoherent light may enter the cavity region where multiple reflections between opposing mirrors create conditions for enhanced light-particle interactions compared to single-pass optical configurations. The cavity geometry may be designed to support resonant modes that correspond to the spectral characteristics of the incoherent light source, enabling efficient energy storage within the cavity region that amplifies the detection signals when particles traverse the optical path.

The spatial filtering function of the optical cavity may serve dual purposes in the detection system operation by both conditioning the incoherent light characteristics and creating an interaction region where particles can be detected with enhanced sensitivity. The spatial filtering process may selectively transmit light rays that propagate within specific angular ranges while attenuating light rays that exceed the acceptance angle of the cavity system. The filtering action may result in transmitted light that exhibits reduced divergence compared to the original incoherent light source, creating more uniform illumination conditions within the particle detection region. The spatial filtering may also contribute to background suppression by rejecting scattered light from surfaces outside the cavity region that could otherwise interfere with particle detection measurements.

The particle access mechanism may enable aerosol particles to enter and traverse the optical cavity region without disrupting the spatial filtering characteristics or compromising the optical isolation of the detection system. The particle flow path may be configured to intersect the filtered light beam at locations where the optical intensity may be sufficient for detection while avoiding interference with the cavity mirrors or other optical components. The particle trajectory through the cavity may be designed to maximize the interaction time between particles and the filtered light, enabling detection of particles across a range of sizes and optical properties. The access mechanism may maintain the environmental isolation of the cavity system while allowing continuous particle monitoring under various flow conditions.

The detection of transmitted light may involve continuous monitoring of optical intensity levels that pass through the cavity system, where changes in transmission characteristics may indicate the presence of particles within the detection region. The transmitted light detection process may employ photodetection techniques that convert optical signals into electrical signals suitable for analysis and processing. The detection system may be configured to establish baseline transmission levels that correspond to particle-free conditions, enabling identification of intensity variations that may be attributed to particle interactions within the cavity. The temporal characteristics of transmission changes may provide information about particle transit times, concentrations, and other parameters relevant to aerosol monitoring applications.

The identification of particle presence may be accomplished through analysis of transmission intensity variations that occur when particles pass through the cavity region and interact with the filtered incoherent light. The particle identification process may involve detection of characteristic signal patterns such as temporary decreases in transmitted light intensity that correspond to particle scattering events within the cavity. The magnitude and duration of intensity changes may be related to particle characteristics such as size, refractive index, and scattering cross-section, enabling quantitative analysis of particle properties based on the optical transmission measurements. The identification process may incorporate signal processing techniques that distinguish between particle-induced transmission changes and other sources of signal variation such as electronic noise or environmental perturbations.

The cavity enhancement mechanism may amplify the particle detection signals through multiple light-particle interactions that occur as the filtered incoherent light undergoes repeated reflections between the cavity mirrors. Each reflection cycle may provide additional opportunities for particles within the cavity region to interact with the light beam, increasing the cumulative scattering effect compared to single-pass detection configurations. The enhancement factor may depend on the cavity finesse, mirror reflectivity, and cavity length, where higher finesse cavities may provide greater signal amplification at the expense of increased sensitivity to cavity alignment and stability requirements. The cavity enhancement may enable detection of smaller particles or operation at lower particle concentrations compared to non-cavity detection systems.

The transmission monitoring approach may provide advantages over scattering-based detection methods by capturing the total effect of particle interactions rather than measuring only a fraction of the scattered light. The transmission measurement may be inherently less sensitive to the specific positioning of detection elements since the transmitted beam characteristics may be determined by the cavity geometry rather than the detector placement. The monitoring process may be less susceptible to background contamination from ambient light sources or scattered light from surfaces outside the cavity region, contributing to improved signal-to-noise ratios for particle detection applications. The transmission-based approach may also facilitate system miniaturization since the detector positioning requirements may be less stringent compared to scattering-based configurations.

The signal processing methodology may involve analysis of temporal patterns in the transmitted light intensity that correspond to particles passing through the cavity region at various velocities and concentrations. The processing algorithms may be designed to identify characteristic signal features such as the amplitude, duration, and shape of transmission decreases that occur during particle detection events. The signal analysis may incorporate statistical methods that account for the random nature of particle arrival times and the distribution of particle sizes within the aerosol stream. The processing system may provide real-time analysis capabilities that enable immediate identification of particle detection events while maintaining data storage for subsequent detailed analysis of particle characteristics and concentration trends.

The system integration may involve coordination between the light generation, spatial filtering, particle access, detection, and signal processing components to achieve optimal overall performance for aerosol monitoring applications. The integration process may rely on careful consideration of component specifications, alignment tolerances, and environmental operating conditions to ensure consistent detection performance across varying deployment scenarios. The integrated system may be designed to operate autonomously with minimal user intervention while providing reliable particle detection data suitable for air quality monitoring, industrial process control, or environmental research applications. The integration approach may emphasize simplicity and cost-effectiveness to enable widespread deployment in applications where traditional particle detection systems may be impractical due to size, cost, or complexity constraints.

The following examples pertain to further embodiments.

Embodiment 1 is an aerosol particle detection system that includes an incoherent light source configured to generate incoherent light, a first mirror and a second mirror positioned to define an optical cavity region therebetween, and a photodetector positioned to detect transmitted light that has passed through the optical cavity region. The optical cavity region is configured to receive the incoherent light from the incoherent light source and to allow particles to pass through the optical cavity region. The photodetector is configured to detect changes in intensity of the transmitted light caused by particles passing through the optical cavity region.

In Embodiment 2, the incoherent light source of Embodiment 1 comprises a light-emitting diode.

In Embodiment 3, the light-emitting diode of Embodiment 2 is configured to emit blue light having a wavelength centered at approximately 430 nanometers.

In Embodiment 4, the optical cavity region of Embodiment 1 has a length between the first mirror and the second mirror of approximately 6-10 millimeters.

In Embodiment 5, the aerosol particle detection system of Embodiment 1 further comprises an optical element positioned between the incoherent light source and the optical cavity region.

In Embodiment 6, the optical element of Embodiment 5 comprises a lens configured to enhance signal transmission through the optical cavity region.

In Embodiment 7, the aerosol particle detection system of Embodiment 1 further comprises an enclosure defining the optical cavity region, wherein the enclosure includes an opening configured to allow particles to enter the optical cavity region.

In Embodiment 8, the opening of Embodiment 7 comprises a hole bored through the enclosure.

In Embodiment 9, the photodetector of Embodiment 1 is configured to detect a decrease in intensity of the transmitted light when particles pass through the optical cavity region.

In Embodiment 10, the incoherent light source of Embodiment 1 is configured to excite multiple cavity modes within the optical cavity region, thereby providing stability against environmental perturbations.

Embodiment 11 is a method for detecting aerosol particles that includes generating incoherent light using an incoherent light source, directing the incoherent light into an optical cavity defined by a first mirror and a second mirror, allowing particles to pass through the optical cavity, detecting transmitted light that has passed through the optical cavity using a photodetector, and identifying presence of particles based on changes in intensity of the transmitted light.

In Embodiment 12, generating incoherent light in the method of Embodiment 11 comprises operating a light-emitting diode.

In Embodiment 13, the light-emitting diode of Embodiment 12 emits blue light having a wavelength centered at approximately 430 nanometers.

In Embodiment 14, identifying presence of particles in the method of Embodiment 11 comprises detecting a decrease in intensity of the transmitted light when particles pass through the optical cavity.

In Embodiment 15, the method of Embodiment 11 further comprises a step of filtering the incoherent light through an optical element positioned between the incoherent light source and the optical cavity to enhance signal transmission.

Embodiment 16 is an aerosol detection apparatus that includes a light-emitting diode configured to emit incoherent light, an optical cavity comprising opposing mirrors that define a cavity region, and a detection system configured to monitor transmission of light through the optical cavity and to detect reductions in transmitted light intensity corresponding to particle scattering events within the cavity region. The optical cavity is configured to spatially filter the incoherent light and to allow aerosol particles to traverse the cavity region.

In Embodiment 17, the light-emitting diode of Embodiment 16 is configured to emit blue light having a wavelength centered at approximately 430 nanometers with a full-width at half-maximum of approximately 20 nanometers.

In Embodiment 18, the optical cavity of Embodiment 16 has a length between the opposing mirrors of approximately 6-10 millimeters.

In Embodiment 19, the aerosol detection apparatus of Embodiment 18 further comprises an enclosure defining the cavity region, wherein the enclosure includes an opening configured to allow aerosol particles to enter the cavity region.

In Embodiment 20, the detection system of Embodiment 19 comprises a photodetector and an amplifier, and the amplifier is configured to amplify signals from the photodetector.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 wt. %” is intended to mean “about 40 wt. %”.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. An aerosol particle detection system, comprising:
an incoherent light source configured to generate incoherent light;
a first mirror and a second mirror positioned to define an optical cavity region therebetween, wherein the optical cavity region is configured to receive the incoherent light from the incoherent light source and to allow particles to pass through the optical cavity region; and
a photodetector positioned to detect transmitted light that has passed through the optical cavity region, wherein the photodetector is configured to detect changes in intensity of the transmitted light caused by particles passing through the optical cavity region.

2. The aerosol particle detection system of claim 1, wherein the incoherent light source comprises a light-emitting diode.

3. The aerosol particle detection system of claim 2, wherein the light-emitting diode is configured to emit blue light having a wavelength centered at approximately 430 nanometers.

4. The aerosol particle detection system of claim 1, wherein the optical cavity region has a length between the first mirror and the second mirror of approximately 6-10 millimeters.

5. The aerosol particle detection system of claim 1, further comprising an optical element positioned between the incoherent light source and the optical cavity region.

6. The aerosol particle detection system of claim 5, wherein the optical element comprises a lens configured to enhance signal transmission through the optical cavity region.

7. The aerosol particle detection system of claim 1, further comprising an enclosure defining the optical cavity region, wherein the enclosure includes an opening configured to allow particles to enter the optical cavity region.

8. The aerosol particle detection system of claim 7, wherein the opening comprises a hole bored through the enclosure.

9. The aerosol particle detection system of claim 1, wherein the photodetector is configured to detect a decrease in intensity of the transmitted light when particles pass through the optical cavity region.

10. The aerosol particle detection system of claim 1, wherein the incoherent light source is configured to excite multiple cavity modes within the optical cavity region, thereby providing stability against environmental perturbations.

11. A method for detecting aerosol particles, comprising:
generating incoherent light using an incoherent light source;
directing the incoherent light into an optical cavity defined by a first mirror and a second mirror;
allowing particles to pass through the optical cavity;
detecting transmitted light that has passed through the optical cavity using a photodetector; and
identifying presence of particles based on changes in intensity of the transmitted light.

12. The method of claim 11, wherein generating incoherent light comprises operating a light-emitting diode.

13. The method of claim 12, wherein the light-emitting diode emits blue light having a wavelength centered at approximately 430 nanometers.

14. The method of claim 11, wherein identifying presence of particles comprises detecting a decrease in intensity of the transmitted light when particles pass through the optical cavity.

15. The method of claim 11, further comprising a step of filtering the incoherent light through an optical element positioned between the incoherent light source and the optical cavity to enhance signal transmission.

16. An aerosol detection apparatus, comprising:
a light-emitting diode configured to emit incoherent light;
an optical cavity comprising opposing mirrors that define a cavity region, wherein the optical cavity is configured to spatially filter the incoherent light and to allow aerosol particles to traverse the cavity region; and
a detection system configured to monitor transmission of light through the optical cavity and to detect reductions in transmitted light intensity corresponding to particle scattering events within the cavity region.

17. The aerosol detection apparatus of claim 16, wherein the light-emitting diode is configured to emit blue light having a wavelength centered at approximately 430 nanometers with a full-width at half-maximum of approximately 20 nanometers.

18. The aerosol detection apparatus of claim 16, wherein the optical cavity has a length between the opposing mirrors of approximately 6-10 millimeters.

19. The aerosol detection apparatus of claim 18, further comprising an enclosure defining the cavity region, wherein the enclosure includes an opening configured to allow aerosol particles to enter the cavity region.

20. The aerosol detection apparatus of claim 19, wherein the detection system comprises a photodetector and an amplifier, and wherein the amplifier is configured to amplify signals from the photodetector.
